(19) United States
(12) Patent Application Publication
(10) Pub. No.: US 2014/0325303 A1
(43) Pub. Date: Oct. 30, 2014

(54) Systems and Methods for Protected Data Encoding

(71) Applicant: LSI CORPORATION, San Jose, CA (US)

(72) Inventors: Shaohua Yang, Santa Clara, CA (US); Anatoli A. Bolotov, San Jose, CA (US); Mikhail I. Grinchuk, San Jose, CA (US)

(73) Assignee: LSI Corporation, San Jose, CA (US)

(21) Appl. No.: 13/875,357

(22) Filed: May 2, 2013

Related U.S. Application Data
(60) Provisional application No. 61/817,620, filed on Apr. 30, 2013.

(51) Int. Cl. G06F 11/10

(52) U.S. Cl. CPC G06F 11/10
USPC 714/752; 714/801

(57) ABSTRACT

The present inventions are related to systems and methods for data processing, and more particularly to systems and methods for encoding data sets.

### CROSS REFERENCE TO RELATED APPLICATION

The present application claims priority to U.S. Pat. App. No. 61/817,620 entitled “Systems and Methods for Protected Data Encoding” and filed on Apr. 30, 2013 by Yang et al. The entirety of the aforementioned reference is incorporated herein by reference for all purposes.

### FIELD OF THE INVENTION

The present inventions are related to systems and methods for data processing, and more particularly to systems and methods for encoding data sets.

### BACKGROUND OF THE INVENTION

Various circuits have been developed that provide for encoding data sets. The resulting encoded data sets are later decoded to yield an original data set. In some cases, the decoding is not able to recover the original data set due to a corruption incurred during the encoding process. Thus, regardless of the complexity of the decoding process, an original data set may not be recoverable.

Hence, for at least the aforementioned reasons, there exists a need in the art for advanced systems and methods for mitigating corruption during data encoding.

### BRIEF SUMMARY OF THE INVENTION

The present inventions are related to systems and methods for data processing, and more particularly to systems and methods for encoding data sets.

Various embodiments of the present invention provide data processing systems that include a data encoder circuit, a parity generator circuit, a parity encoder circuit, and an error flag generation circuit. The data encoder circuit is operable to apply a first encoding algorithm to a data input to yield an encoded data output. The parity generator circuit is operable to generate a parity value based upon the data input. The parity encoder circuit is operable to apply a second encoding algorithm to the parity value to yield an encoded parity output. The error flag generation circuit is operable indicate an error in the encoded data output based at least in part on the encoded parity output.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including a path protected data encoder circuit in accordance with some embodiments of the present invention;

FIG. 2 depicts a communication system including a path protected data encoder circuit in accordance with different embodiments of the present invention;

FIG. 3 shows a path protected data encoder circuit in accordance with some embodiments of the present invention;

FIG. 4 shows a method for path protected data encoding in accordance with some embodiments of the present invention;

FIG. 5 shows another path protected data encoder circuit in accordance with other embodiments of the present invention; and

FIG. 6 shows another method for path protected data encoding in accordance with various embodiments of the present invention.

### DETAILED DESCRIPTION OF THE INVENTION

The present inventions are related to systems and methods for data processing, and more particularly to systems and methods for encoding data sets.

It has been determined that during the encoding process corruption may occur, for example, due to alpha particles. Some embodiments of the present invention operate to protect against propagation of a corrupted codeword. As an example, one embodiment of the present invention provides for calculating a running parity value for an incoming data set, and encoding the running parity value to yield an encoded parity value. The user data is also encoded to yield an encoded output. If at any time the encoded parity value is not equal to the encoded output, an encoding error is indicated. Where an encoding error is indicated, the current encoded output is discarded and the encoding process is restarted.

Various embodiments of the present invention provide data processing systems that include a data encoder circuit, a parity generator circuit, a parity encoder circuit, and an error flag generation circuit. The data encoder circuit is operable to apply a first encoding algorithm to a data input to yield an encoded data output. The parity generator circuit is operable to generate a parity value based upon the data input. The parity encoder circuit is operable to apply a second encoding algorithm to the parity value to yield an encoded parity output. The error flag generation circuit is operable indicate an error in the encoded data output based at least in part on the encoded parity output.

In some instances of the aforementioned embodiments, the first encoding algorithm includes: multiplying the data input by an encoding matrix to yield a data product; and accumulating multiple instances of the data product to yield the encoded data output, and the second encoding algorithm includes multiplying the parity value by the encoding matrix to yield a parity product; accumulating multiple instances of the parity product to yield the encoded parity output. In some instances of the aforementioned embodiments, the error generation circuit includes a comparator circuit operable to compare the encoded parity output with the encoded data output, and to indicate an error when the encoded parity output is not equal to the encoded data output.

In various instances of the aforementioned embodiments, the parity value is a first parity value generated based upon a first subset of the data input, and the parity generation circuit is further operable to generate a second parity value based upon a second subset of the data input. In such instance, the first encoding algorithm includes multiplying the data input by an encoding matrix to yield a data product; and accumulating multiple instances of the data product to yield the encoded data output. The second encoding algorithm includes: multiplying the first parity value by a first sub-matrix to yield a first parity product; accumulating multiple instances of the first parity product to yield a first interim output; multiplying the second parity value by a second sub-matrix to yield a second parity product; and accumulating multiple instances of the second parity product to yield a second interim output. The encoded data output incorporates the first interim output and the second interim output.

In various instances of the aforementioned embodiments, the data processing system further includes a data decoder circuit operable to apply a data decode algorithm to the encoded data output to recover the data input. In some cases, the data decoder circuit is a low density parity check decoder circuit. In various cases, the data processing system is implemented as part of a communication device, and the encoded output is transferred to the data decoder circuit via a communication medium. In some such cases, the encoded parity output is not transferred via the communication medium. In various cases, the data processing system is implemented as part of a storage device, and the encoded output is transferred to the data decoder circuit via a storage medium. In some such cases, the encoded parity output is not transferred via the storage medium. In some instances of the aforementioned embodiments, the system is implemented as part of an integrated circuit.

Turning to FIG. 1, a storage system 100 including a read channel circuit 110 with a path protected data encoder circuit is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 178 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel module 164 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit.

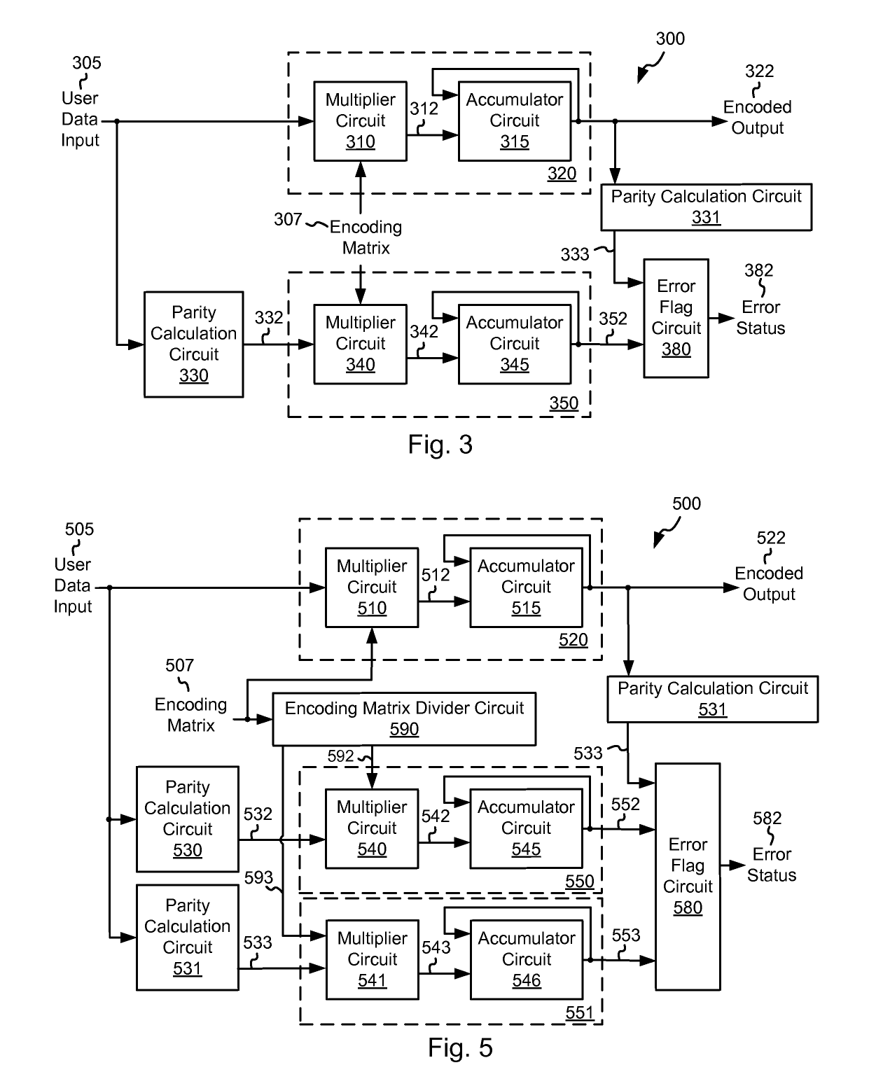

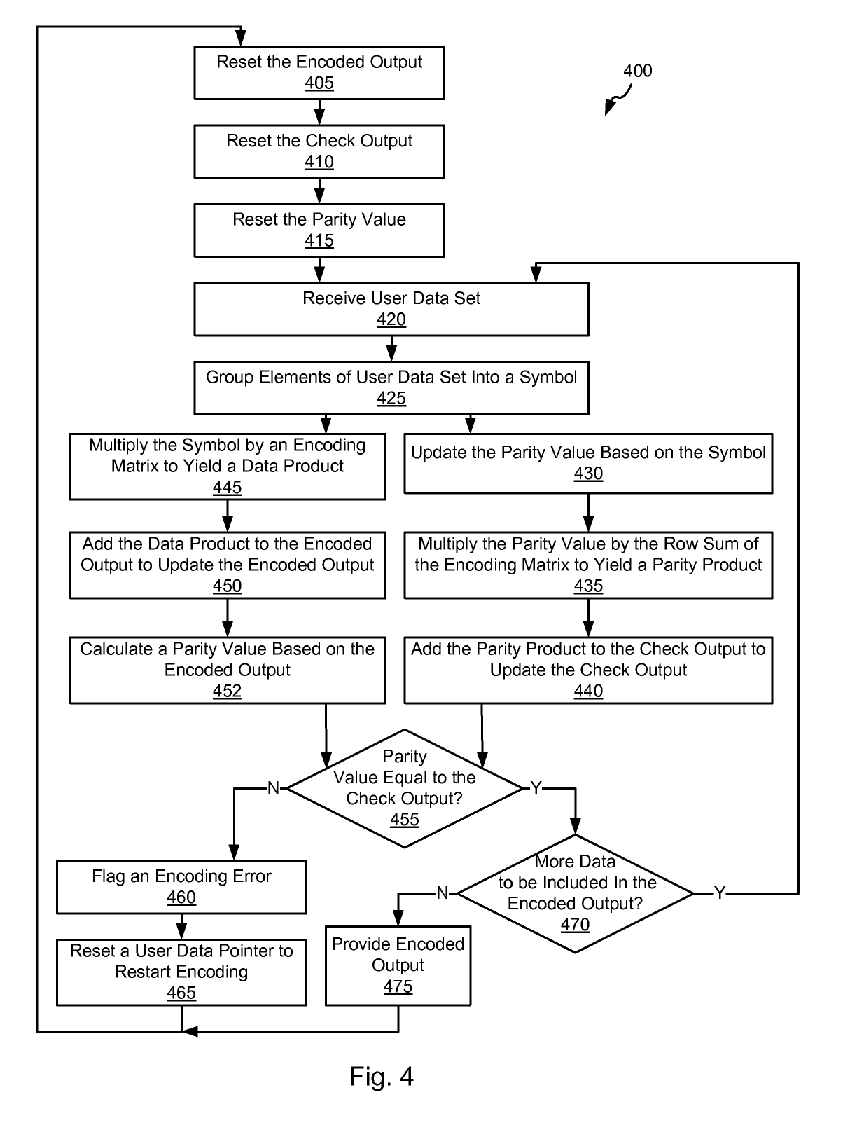

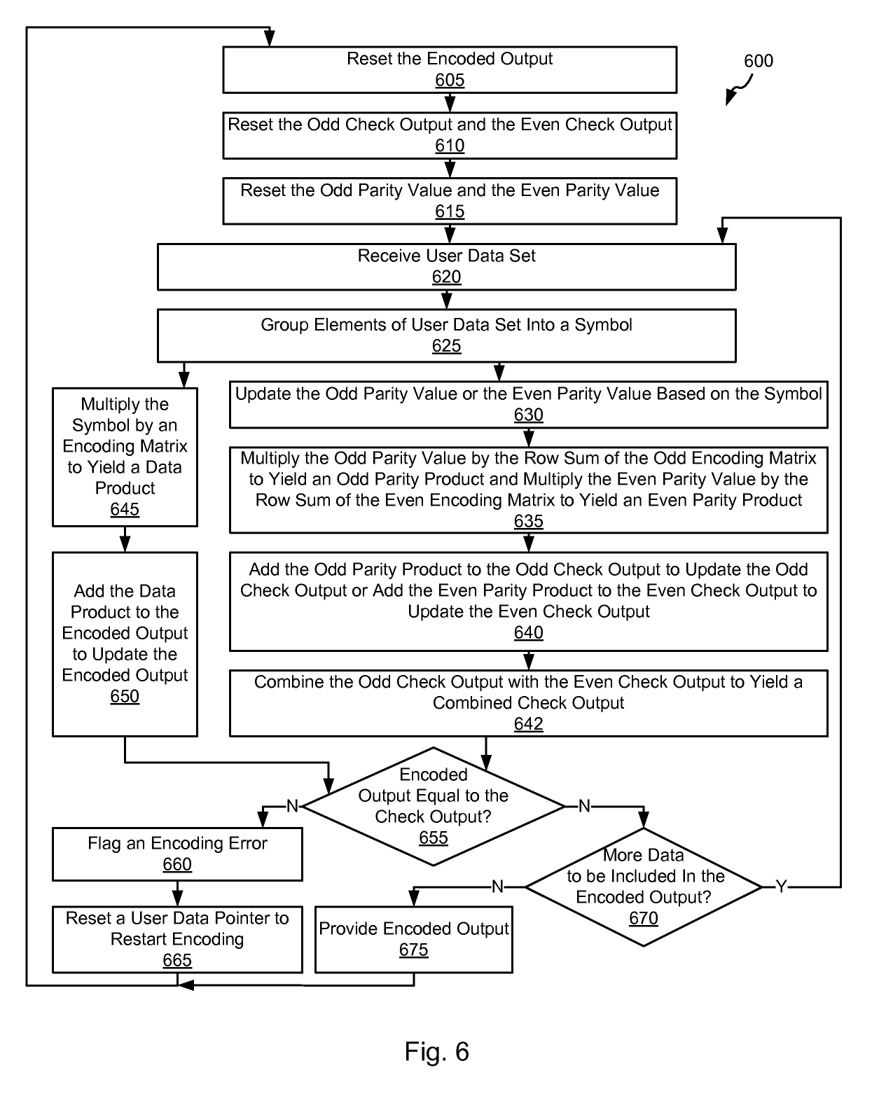

In a write operation, a user data set is encoded using the path protected data encoder circuit. The resulting encoded output is written to disk platter 178 via read/write head assembly 176 that is accurately positioned over disk platter 178. The path protected data encoder circuit may be implemented, for example, consistent with that discussed below in relation to FIG. 3 or FIG. 5. Further, the path protected data encoding may be done, for example, consistent with the method discussed below in relation to FIG. 4 or the method discussed below in relation to FIG. 6.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. In such cases, the encoding may include a low density parity check encoding as is known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

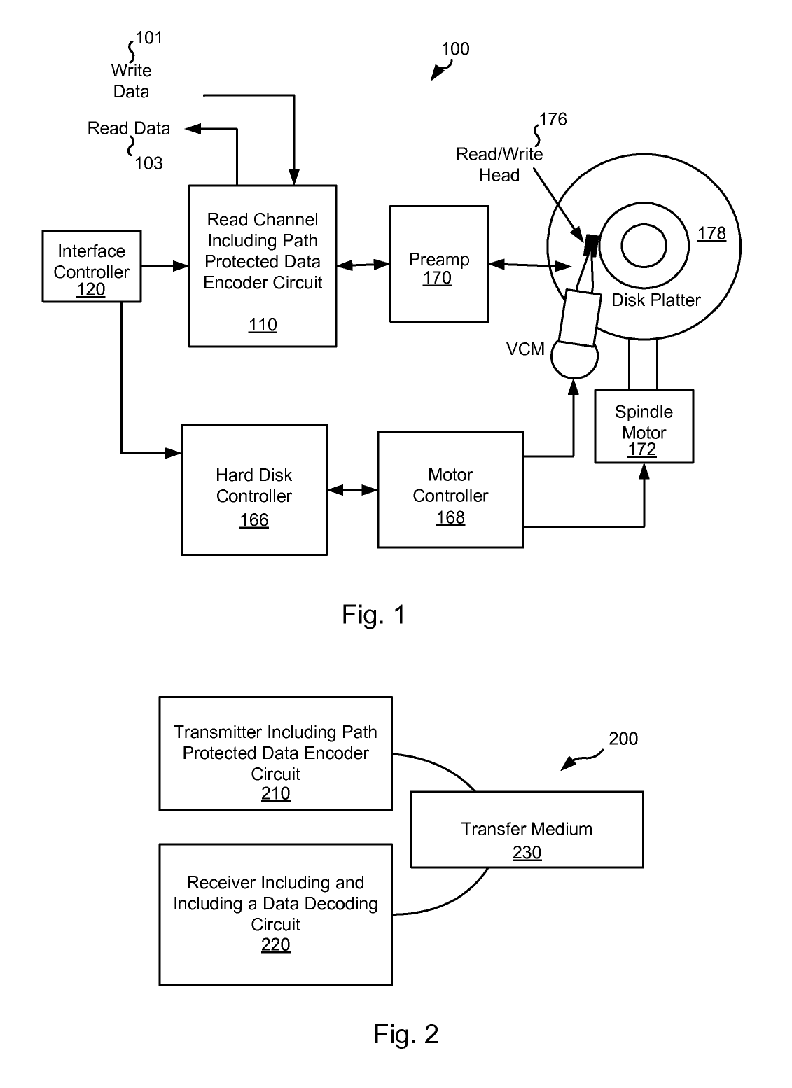

Turning to FIG. 2, a communication system 200 including a receiver 220 with a ratio metric based sync mark detector circuit is shown in accordance with different embodiments of the present invention. Communication system 200 includes a transmitter 210 that includes a protected data path encoder circuit in accordance with one or more embodiments of the present invention. The path protected data encoder circuit may be implemented, for example, consistent with that discussed below in relation to FIG. 3 or FIG. 5. Further, the path protected data encoding may be done, for example, consistent with the method discussed below in relation to FIG. 4 or the method discussed below in relation to FIG. 6. Transmitter 210 is operable to transmit encoded information via a transfer medium 230 as is known in the art. The encoded data is received from transfer medium 230 by receiver 220. A data decoding circuit included as part of receiver 220 performs a data decoding on the received data set to recover the originally encoded data set.

Turning to FIG. 3, a path protected data encoder circuit 300 is shown in accordance with some embodiments of the present invention. Path protected data encoder circuit 300 includes a main path data encoder circuit 320, a secondary path data encoder circuit 350, a parity calculation circuit 331, a parity calculation circuit 330, and an error flag circuit 380. Main path data encoder circuit 320 includes a multiplier circuit 310 and an accumulator circuit 315. Multiplier circuit 310 multiplies a user data input by an encoding matrix 307 to yield a product 312 in accordance with the following equation:

Product 312=H matrix 307×User Data Input 305.

H-matrix 307 is a quasi cyclic matrix that may be either binary or non-binary. The following is an example of a 6×6 binary matrix that may be used as H-matrix 307:

$$H matrix 307 = [ \begin{matrix}0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0\end{matrix} ] .$$

The following is an example of a 6×6 non-binary matrix that may be used as H-matrix 307, where i=‘01’, j=‘10’ and k=‘11’:

$$H matrix 307 = [ \begin{matrix}0 & 0 & k & 0 & j & 0 \\ 0 & 0 & 0 & k & 0 & j \\ j & 0 & 0 & 0 & k & 0 \\ 0 & j & 0 & 0 & 0 & k \\ k & 0 & j & 0 & 0 & 0 \\ 0 & k & 0 & j & 0 & 0\end{matrix} ] .$$

Of note, while 6×6 matrices are shown for discussion purposes, matrices of other sizes may be used in relation to different embodiments of the present invention. Further, while the non-binary matrix is shown using two bit symbols (i.e., i, j, k), three or more bits per symbol may be used in relation to different embodiments of the present invention. Further, it should be noted that H matrix 307 may be one of many circulants within an overall encoding matrix. As used herein, the phrase encoding matrix is used generally to describe both an overall encoding matrix and individual sub-matrices or circulants. The processing described herein may be used to provide protection to a codeword encoded using an overall encoding matrix with the processing being performed on a circulant granularity.

Product 312 is provided to an accumulator circuit 315 that accumulates a number of instances of product 312 to yield an encoded output 322 in accordance with the following equation:

Encoded Output 322[i+1]=Encoded Output 322[i]+Product 312[i+1],

where i indicates a previous state and i+1 indicates a next state. In addition to being provided as an output, encoded output 322 is provided to parity calculation circuit 331 that calculates a parity value 333. Parity value 333 is calculated in accordance with the following equation:

Parity Value 333[N−1]=a[0]+a[1]+a[2]+ . . . +a[N−1],

where a represents encoded output, and N is the total number of elements in encoded output 322 that are to be incorporated into parity value 333. Parity value 333 is provided to error flag circuit 380.

Parity calculation circuit 330 calculates a parity value 332 that is provided to secondary path data encoder circuit 350. Parity value 332 is calculated in accordance with the following equation:

Parity Value 332[N−1]=u[0]+u[1]+u[2]+ . . . +u[N−1],

where u represents user data input 305, and N is the total number of elements of user data input 305 that are to be incorporated into parity value 332. Of note, parity value 332 is valid as each element of user data input 305 is added. Thus, for example, where parity value 332 is calculated based upon u[0] only, the resulting Parity Value 332[0] is a valid parity value for those limited inputs. As another example, parity value 332 is calculated based upon u[0] and u[1] only, the resulting Parity Value 332[1] is a valid parity value for those limited inputs.

Where the following definition holds:

H′=H matrix 307[0,m]+H matrix 307[1,m]+ . . . +H matrix 307 [N−1,m],

where N is the total number of elements, and m is any of 0 through N−1 for the quasi-cyclic H matrix 307. Thus, H′ is the row sum of H matrix 307. It should be noted that while in some embodiments of the present invention the row sum is used, in other embodiments of the present invention a column sum may be used. The following relationship thus follows:

$$s [ m ] = h [ m , 0 ] * u [ 0 ] + h [ m , 1 ] * u [ 1 ] + … + h [ m , N - 1 ] * u [ N - 1 ] ;$$

$$and$$

$$\begin{matrix}s [ 0 ] + s [ 1 ] + … + s [ N - 1 ] = ( h [ 0 , 0 , ] + … + h [ N - 1 , 0 ] ) * \\ u [ 0 ] + … + ( h [ N - 1 , 0 ] + … + \\ h [ N - 1 , N - 1 ] ) * u [ N - 1 ] \\ = ( h [ 0 , 0 ] + … + h [ N - 1 , 0 ] ) * \\ ( u [ 0 ] + u [ 1 ] + … + u [ N - 1 ] )\end{matrix} ,$$

and where h[x,y] corresponds to H matrix 307, then the following is true:

s[0]+s[1]+ . . . +s[N−1]=H′*Parity Value 332.

Based upon this relationship, processing parity value 332 through secondary path data encoder circuit 350 yields an encoded parity value 352 that is comparable to encoded output 322 to assure that the encoding was not corrupted.

In particular, parity value 332 is provided to a multiplier circuit 340 where it is multiplied by encoding matrix 307 to yield a product 342 in accordance with the following equation:

Product 342=H′×Parity Value 332,

where H′ is the row sum described in the preceding paragraph. Product 342 is provided to accumulator circuit 345 that accumulates a number of instances of product 342 to yield encoded parity value 352 in accordance with the following equation:

Encoded Parity Value 352[i+1]=Encoded Parity Value 352[i]+Product 342[i+1],

where i indicates a previous state and i+1 indicates a next state.

Encoded parity value 352 is provided to an error flag circuit 380 where it is compared against parity value 333 to generate an error status 382. In particular, error status 382 is asserted to indicate an error whenever parity value 333 is not equal to encoded parity value 352. Thus, if at any time the following equation is true, error flag circuit 380 asserts error status 382 to indicate the occurrence of an encoding error:

Encoded Output 322[0]+Encoded Output 322[1]+ . . . +Encoded Output 322[N−1]!=Encoded Parity Value 352.

Thus, if at any time a processing circulant renders the aforementioned equation untrue, an error flag may be asserted causing a restart of the processing. In such a case, each time user data input 305 corresponding to a complete circulant is processed, error flag circuit 380 performs the comparison and determines whether to assert error status 382. If an any time from 0 to N−1 error status 382 is asserted by error flag circuit 380 is asserted, it remains asserted indicating an error. Where error status 382 is asserted, encoded output 322 is discarded and encoding of the user data set is performed again.

Turning to FIG. 4, a flow diagram 400 shows a method for path protected data encoding in accordance with some embodiments of the present invention. Following flow diagram 400, an initializing process of resetting an encoded output (block 405), resetting a check output (block 410), and resetting a parity value (block 415). A user data set is received (block 420), and the elements of the user data set are grouped into symbols (block 425). In a binary encoding system, the symbols are single bits. In non-binary encoding systems, the symbols are multi-bit symbols. As an example, in a two bit symbol system, the received user data bits are arranged into two bit symbols.

Each received symbol is multiplied by an encoding matrix to yield a data product (block 445). The encoding matrix may be a quasi-cyclic matrix that is either binary or non-binary depending upon whether the symbols are binary or non-binary. The following is an example of a 6×6 binary matrix that may be used as the encoding matrix:

$$Encoding Matrix = [ \begin{matrix}0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0\end{matrix} ] .$$

The following is an example of a 6×6 non-binary matrix that may be used as the encoding matrix, where i=‘01’, j=‘10’ and k=‘11’:

$$Encoding Matrix = [ \begin{matrix}0 & 0 & k & 0 & j & 0 \\ 0 & 0 & 0 & k & 0 & j \\ j & 0 & 0 & 0 & k & 0 \\ 0 & j & 0 & 0 & 0 & k \\ k & 0 & j & 0 & 0 & 0 \\ 0 & k & 0 & j & 0 & 0\end{matrix} ] .$$

Of note, while 6×6 matrices are shown for discussion purposes, matrices of other sizes may be used in relation to different embodiments of the present invention. Further, while the non-binary matrix is shown using two bit symbols (i.e., i, j, k), three or more bits per symbol may be used in relation to different embodiments of the present invention. The data product is added to the previous instance of the encoded output to yield an updated encoded output (block 450). Once the updated encoded output is complete (e.g., corresponds to a complete circulant), a parity value of the encoded output is calculated (block 452).

In parallel, the parity value is updated based upon the most recently received symbol (block 430). As each new parity value is calculated (block 430), it is multiplied by a row sum of the encoding matrix to yield a parity product (block 435). Again, while embodiments herein are described as using a row sum, other embodiments may use a column sum. The parity product is added to a previous instance of the check output to yield an updated check output (block 440).

As each symbol of the user data set is processed, the current parity value is compared with the current check output (block 455). Where the parity value is not equal to the current check output (block 455), an encoding error is flagged (block 460) and a user data pointer is reset to restart the encoding process on the received user data set (block 465). Alternatively, where the parity value is equal to the current check output (block 455), it is determined whether more data (i.e., additional of user data set) is to be included in the encoded output (block 470). Where more data is to be used (block 470), the processes of blocks 420 through 455 is performed for the next instance of the user data set. Alternatively, where no more data is to be used (block 470), the encoded output is provided (block 475).

Turning to FIG. 5, another path protected data encoder circuit 500 is shown in accordance with other embodiments of the present invention. Path protected data encoder circuit 500 includes a main path data encoder circuit 520, a first secondary path data encoder circuit 550, a second secondary path encoder circuit 551, a main parity calculation circuit 531, a first parity calculation circuit 530, a second parity calculation circuit 531, and an error flag circuit 580. Main path data encoder circuit 520 includes a multiplier circuit 510 and an accumulator circuit 515. Multiplier circuit 510 multiplies a user data input by an encoding matrix 507 to yield a product 512 in accordance with the following equation:

Product 512=H matrix 507×User Data Input 505.

H-matrix 507 is a quasi cyclic matrix that may be either binary or non-binary. The following is an example of a 6×6 binary matrix that may be used as H-matrix 507:

$$H matrix 507 = [ \begin{matrix}0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0\end{matrix} ] .$$

The following is an example of a 6×6 non-binary matrix that may be used as H-matrix 507, where i=‘01’, j=‘10’ and k=‘11’:

$$H matrix 507 = [ \begin{matrix}0 & 0 & k & 0 & j & 0 \\ 0 & 0 & 0 & k & 0 & j \\ j & 0 & 0 & 0 & k & 0 \\ 0 & j & 0 & 0 & 0 & k \\ k & 0 & j & 0 & 0 & 0 \\ 0 & k & 0 & j & 0 & 0\end{matrix} ] .$$

Of note, while 6×6 matrices are shown for discussion purposes, matrices of other sizes may be used in relation to different embodiments of the present invention. Further, while the non-binary matrix is shown using two bit symbols (i.e., i, j, k), three or more bits per symbol may be used in relation to different embodiments of the present invention.

Product 512 is provided to accumulator circuit 515 that accumulates a number of instances of product 512 to yield an encoded output 522 in accordance with the following equation:

Encoded Output 522[i+1]=Encoded Output 522[i]+Product 512[i+1],

where i indicates a previous state and i+1 indicates a next state. In addition to being provided as an output, encoded output 522 is provided to parity calculation circuit 531 that calculates a parity value 533. Parity value 533 is calculated in accordance with the following equation:

Parity Value 533[N−1]=a[0]+a[1]+a[2]+ . . . +a[N−1],

where a represents encoded output, and N is the total number of elements in encoded output 522 that are to be incorporated into parity value 533. Parity value 533 is provided to error flag circuit 580.

Parity calculation circuit 530 calculates a parity value 532 based upon even instances of user data input 505, and provides parity value 532 to secondary path data encoder circuit 550. Parity value 532 is calculated in accordance with the following equation:

Parity Value 532[N−1]=u[0]+u[2]+u[4]+ . . . +u[N−2],

where u represents user data input 505, and N is the total number of elements of user data input 505 that are to be incorporated into parity value 532 and a parity value 533. Of note, parity value 532 is valid as each element of user data input 505 is added. Thus, for example, where parity value 532 is calculated based upon u[0] only, the resulting Parity Value 532[0] is a valid parity value for those limited inputs. As another example, parity value 532 is calculated based upon u[0] and u[2] only, the resulting Parity Value 332[2] is a valid parity value for those limited inputs.

Similarly, parity calculation circuit 531 calculates parity value 533 based upon even instances of user data input 505, and provides parity value 533 to secondary path data encoder circuit 551. Parity value 533 is calculated in accordance with the following equation:

Parity Value 533[N−1]=u[2]+u[4]+u[6]+ . . . +u[N−1],

where u represents user data input 505, and N is the total number of elements of user data input 505 that are to be incorporated into parity value 532 and a parity value 533. Of note, parity value 532 is valid as each element of user data input 505 is added. Thus, for example, where parity value 533 is calculated based upon u[1] only, the resulting Parity Value 532[1] is a valid parity value for those limited inputs. As another example, parity value 533 is calculated based upon u[1] and u[3] only, the resulting Parity Value 532[3] is a valid parity value for those limited inputs.

An encoding matrix divider circuit 590 divides H-matrix 507 into two sub-matrices 592, 593. Where H-matrix 507, is for example:

$$H matrix 507 = [ \begin{matrix}0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0\end{matrix} ] ,$$

the two sub matrices would correspond to the following:

$$Sub \text{-} matrix 592 = [ \begin{matrix}0 & 0 & 1 \\ 1 & 0 & 0 \\ 0 & 1 & 0\end{matrix} ] , \\ and$$

$$Sub \text{-} matrix 593 = [ \begin{matrix}0 & 0 & 1 \\ 1 & 0 & 0 \\ 0 & 1 & 0\end{matrix} ] .$$

A multiplier circuit 540 multiplies parity value 532 by sub-matrix 592 to yield a product 542 in accordance with the following equation:

Product 542=Row Sum of Sub−matrix 592×Parity Value 532.

Product 542 is provided to accumulator circuit 545 that accumulates a number of instances of product 542 to yield encoded parity value 552 in accordance with the following equation:

Encoded Parity Value 552[i+1]=Encoded Parity Value 552[i]+Product 542[i+1],

where i indicates a previous state and i+1 indicates a next state.

A multiplier circuit 541 multiplies parity value 533 by sub-matrix 593 to yield a product 543 in accordance with the following equation:

Product 543=Row Sum of Sub−matrix 593×Parity Value 533.

Product 543 is provided to accumulator circuit 546 that accumulates a number of instances of product 543 to yield encoded parity value 553 in accordance with the following equation:

Encoded Parity Value 553[i+1]=Encoded Parity Value 553[i]+Product 543[i+1],

where i indicates a previous state and i+1 indicates a next state.

Encoded parity value 552 and encoded parity value 553 are provided to error flag circuit 580. As each instance of user data input 505 is processed, error flag circuit 580 combines encoded parity value 552 and encoded parity value 553 to yield a comparison value, and then compares the comparison value with parity value 533. Where parity value 533 is not equal to the comparison value, error flag circuit 580 asserts error status 582 to indicate the occurrence of an encoding error.

Turning to FIG. 6, a flow diagram 600 shows another method for path protected data encoding in accordance with other embodiments of the present invention. Following flow diagram 600, an initializing process of resetting an encoded output (block 605), resetting a check output (block 610), and resetting both an odd parity value and an even parity value (block 615). A user data set is received (block 620), and the elements of the user data set are grouped into symbols (block 625). In a binary encoding system, the symbols are single bits. In non-binary encoding systems, the symbols are multi-bit symbols. As an example, in a two bit symbol system, the received user data bits are arranged into two bit symbols.

Each received symbol is multiplied by an encoding matrix to yield a data product (block 645). The encoding matrix may be a quasi-cyclic matrix that is either binary or non-binary depending upon whether the symbols are binary or non-binary. The following is an example of a 6×6 binary matrix that may be used as the encoding matrix:

$$Encoding Matrix = [ \begin{matrix}0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0\end{matrix} ] .$$

The following is an example of a 6×6 non-binary matrix that may be used as the encoding matrix, where i=‘01’, j=‘10’ and k=‘11’:

$$Encoding Matrix = [ \begin{matrix}0 & 0 & k & 0 & j & 0 \\ 0 & 0 & 0 & k & 0 & j \\ j & 0 & 0 & 0 & k & 0 \\ 0 & j & 0 & 0 & 0 & k \\ k & 0 & j & 0 & 0 & 0 \\ 0 & k & 0 & j & 0 & 0\end{matrix} ] .$$

Of note, while 6×6 matrices are shown for discussion purposes, matrices of other sizes may be used in relation to different embodiments of the present invention. Further, while the non-binary matrix is shown using two bit symbols (i.e., i, j, k), three or more bits per symbol may be used in relation to different embodiments of the present invention. The data product is added to the previous instance of the encoded output to yield an updated encoded output (block 650).

In parallel, one of the odd parity value and the even parity value is updated based upon the most recently received symbol (block 630). As each new odd parity value is calculated (block 630), it is multiplied by a row sum of an odd encoding matrix to yield an odd parity product; and as each new even parity value is calculated (block 630), it is multiplied by a row sum of an even encoding matrix to yield an even parity product (block 635). Each odd parity product is added to a previous instance of an odd check output to yield an updated odd check output, and each even parity product is added to a previous instance of an even check output to yield an updated even check output (block 640). The most recent odd check output and even check output are then combined to yield a combined check output (block 642).

As each symbol of the user data set is processed, the current encoded output is compared with the current combined check output (block 655). Where the encoded output is not equal to the current combined check output (block 655), an encoding error is flagged (block 660) and a user data pointer is reset to restart the encoding process on the received user data set (block 665). Alternatively, where the encoded output is equal to the current check output (block 655), it is determined whether more data (i.e., additional of user data set) is to be included in the encoded output (block 670). Where more data is to be used (block 670), the processes of blocks 620 through 655 is performed for the next instance of the user data set. Alternatively, where no more data is to be used (block 670), the encoded output is provided (block 675).

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the system comprising:
a data encoder circuit operable to apply a first encoding algorithm to a data input to yield an encoded data output;
a parity generator circuit operable to generate a parity value based upon the data input;
a parity encoder circuit operable to apply a second encoding algorithm to the parity value to yield an encoded parity output; and
an error flag generation circuit operable indicate an error in the encoded data output based at least in part on a combination of the encoded parity output.

2. The data processing system of claim 1, wherein:
the first encoding algorithm includes:
multiplying the data input by an encoding matrix to yield a data product;
accumulating multiple instances of the data product to yield the encoded data output;
the second encoding algorithm includes:
multiplying the parity value by a row sum of the encoding matrix to yield a parity product;
accumulating multiple instances of the parity product to yield the encoded parity output.

3. The data processing system of claim 2, wherein the error generation circuit comprises:
a comparator circuit operable to compare the encoded parity output with the encoded data output, and to indicate an error when the encoded parity output is not equal to the encoded data output.

4. The data processing system of claim 1, wherein the error generation circuit comprises:
a comparator circuit operable to compare the encoded parity output with the encoded data output, and to indicate an error when the encoded parity output is not equal to the encoded data output.

5. The data processing system of claim 1, wherein the parity value is a first parity value generated based upon a first subset of the data input, and wherein the parity generation circuit is further operable to generate a second parity value based upon a second subset of the data input, and wherein:
the first encoding algorithm includes:
multiplying the data input by an encoding matrix to yield a data product;
accumulating multiple instances of the data product to yield the encoded data output;
the second encoding algorithm includes:
multiplying the first parity value by a row sum of a first sub-matrix to yield a first parity product;
accumulating multiple instances of the first parity product to yield a first interim output;
multiplying the second parity value by a row sum of a second sub-matrix to yield a second parity product;
accumulating multiple instances of the second parity product to yield a second interim output.

6. The data processing system of claim 5, wherein the first sub-matrix and the second sub-matrix are derived from the encoding matrix.

7. The data processing system of claim 1, wherein the encoded data output incorporates the first interim output and the second interim output.

8. The data processing system of claim 1, wherein the data processing system further comprises:
a data decoder circuit operable to apply a data decode algorithm to the encoded data output to recover the data input.

9. The data processing system of claim 8, wherein the data decoder circuit is a low density parity check decoder circuit.

10. The data processing system of claim 8, wherein the data processing system is implemented as part of a communication device, and wherein the encoded output is transferred to the data decoder circuit via a communication medium.

11. The data processing system of claim 10, wherein the encoded parity output is not transferred via the communication medium.

12. The data processing system of claim 8, wherein the data processing system is implemented as part of a storage device, and wherein the encoded output is transferred to the data decoder circuit via a storage medium.

13. The data processing system of claim 12, wherein the encoded parity output is not transferred via the storage medium.

14. The data processing system of claim 1, wherein the system is implemented as part of an integrated circuit.

15. A method for data transfer, the method comprising:
applying a first encoding algorithm to a data input to yield an encoded data output;
generating a parity value based upon the data input;
applying a second encoding algorithm to the parity value to yield an encoded parity output; and
generating an error flag based at least in part on a con
asserting an error flag to indicate an error in the encoded data output based at least in part on the encoded parity output.

16. The method of claim 15, wherein:
applying the first encoding algorithm includes:
multiplying the data input by an encoding matrix to yield a data product;
accumulating multiple instances of the data product to yield the encoded data output; and
applying the second encoding algorithm includes:
multiplying the parity value by a row sum of the encoding matrix to yield a parity product;
accumulating multiple instances of the parity product to yield the encoded parity output.

17. The method of claim 16, wherein asserting the error flag comprises:
comparing the encoded parity output with the encoded data output; and
asserting the error flag when the encoded parity output is not equal to the encoded data output.

18. The method of claim 15, wherein the parity value is a first parity value generated based upon a first subset of the data input, and wherein the method further comprises:
generating a second parity value based upon a second subset of the data input, and wherein:
applying the first encoding algorithm includes:
multiplying the data input by an encoding matrix to yield a data product;
accumulating multiple instances of the data product to yield the encoded data output;
applying the second encoding algorithm includes:
multiplying the first parity value by a row sum of a first sub-matrix to yield a first parity product;
accumulating multiple instances of the first parity product to yield a first interim output;
multiplying the second parity value by a row sum of a second sub-matrix to yield a second parity product;
accumulating multiple instances of the second parity product to yield a second interim output.

19. The method of claim 18, wherein the encoded data output incorporates the first interim output and the second interim output.

20. A storage device comprising:
an encoding circuit including:
a data encoder circuit operable to apply a first encoding algorithm to a data input to yield an encoded data output;
a parity generator circuit operable to generate a parity value based upon the data input;
a parity encoder circuit operable to apply a second encoding algorithm to the parity value to yield an encoded parity output; and
an error flag generation circuit operable indicate an error in the encoded data output based at least in part on a combination of the encoded parity output;
a storage medium operable to store an information set derived from the encoded data output; and
a decoding circuit operable to apply a data decode algorithm to the encoded data output to recover the data input.
